(19) United States
(12) Patent Application Publication
(10) Pub. No.: US 2026/0225012 A1
(43) Pub. Date: Aug. 6, 2026

(54) Filter Apparatus and Filter Element

(71) Applicant: HYDAC Filtertechnik GmbH, Sulzbach / Saar (DE)

(72) Inventors: Michael Sakraschinsky, St. Ingbert (DE); Stefan Hennes, Neunkirchen (DE); Patrick Maurer, Sulzbach (DE); Martin Rudi Braune, Brebach-Fechingen (DE)

(73) Assignee: HYDAC Filtertechnik GmbH, Sulzbach / Saar (DE)

(21) Appl. No.: 19/135,656

(22) PCT Filed: Jun. 13, 2024
(86) PCT No.: PCT/EP2024/066346

§ 371 Date: Jun. 4, 2025

(30) Foreign Application Priority Data
Jul. 18, 2023 (DE) 10 2023 003 101.1

(51) Int. Cl. B01D 35/147; B01D 29/60; B01D 35/143

(52) U.S. Cl. CPC B01D 35/147; B01D 29/606; B01D 35/143; B01D 2201/16; B01D 2201/291; B01D 2201/4007

(57) ABSTRACT

The disclosure relates to a filter apparatus comprising a filter housing at least comprising a housing upper part and a housing lower part, which is provided for exchangeably receiving a filter element at least partly; and a control device for controlling fluid flows in the housing upper part, which control device, in a blocking position, blocks a fluidic connection between a fluid inlet and a fluid outlet and, in an unblocking position, unblocks said fluidic connection, wherein, by means of an actuation device on the filter element, the control device can be controlled, when the housing lower part is disconnected from the housing upper part, the control device moves into the blocking position and, when the housing lower part is attached to the housing upper part, the unblocking position is established.

### CROSS-REFERENCE TO RELATED APPLICATIONS

This application claims priority to German Patent Application DE 10 2023 003 101.1, filed on Jul. 18, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter apparatus comprising a filter housing at least consisting of a housing upper part and a housing lower part, which is provided for exchangeably receiving a filter element at least partly, and comprising a control device for controlling fluid flows in the housing upper part, said control device, in a blocking position, blocking a fluidic connection between a fluid inlet and a fluid outlet and, in a release position, releasing said fluidic connection, wherein, by means of an actuation device on the filter element, the control device can be controlled such that, when the housing lower part is disconnected from the housing upper part, the control device moves into the blocking position and, when the housing lower part is attached to the housing upper part, the release position is established.

The disclosure also relates to a filter element which is in particular intended for use in such a filter apparatus.

DE 10 2021 002 511 A1 discloses a filter apparatus having a filter housing comprising at least two connection points, such as an inlet for unfiltered medium and an outlet for filtrate, and receiving a replaceable filter element, wherein a valve device is provided as a control device, which, in an open position, allows a fluid flow between one of the connection points and the filter element and, in a closed position, blocks this fluid flow, and wherein the valve device can also be moved to and fro between the open position and the closed position by means of an actuation device on the filter element. The valve device comprises a spring-loaded inflow valve which is arranged in the fluid flow between the inlet and an outer face of the filter element and a spring-loaded outflow valve which is arranged in the fluid flow between an inner face of the filter element and the outlet.

DE 10 2021 002 024 A1 discloses a comparable filter apparatus and associated filter element, wherein an inflow valve is arranged in the fluid flow between the inlet and an outer face of the filter element and comprises an inflow valve closing element as a control device, said closing element being formed by a cylinder wall portion provided with an opening, said wall portion being movably guided in a slit in the filter housing and, with its opening, in the open position of the control device, overlapping with the inlet.

When installing the filter element in the filter apparatus, said filter element is first inserted in a housing lower part and then pushed into a housing upper part of the filter apparatus. The housing lower part is then subsequently screwed onto the housing upper part, the inserted filter element also being rotated in this process and, in so doing, the inflow valve is moved into the open position. When the filter element is fully screwed in and in this manner attached to the housing upper part, coupling elements corresponding to one another on the lower end cap of the filter element and on the bottom of the housing lower part are able to slide on one another via their respective inclined surfaces so as to achieve a kind of ratchet coupling and the housing lower part can be fully screwed onto the housing upper part to obtain an operating position without the filter element being further rotated in this process.

### SUMMARY

A need exists to provide an improved solution in order to make it possible to control fluid flows in the context of hydraulic devices in a particular functionally reliable manner.

The need is addressed by the subject matter of the independent claim(s). Embodiments of the invention are described in the dependent claims, the following description, and the drawings.

### BRIEF DESCRIPTION OF THE DRAWINGS

FIG. 1 takes the form of a longitudinal sectional view showing an example filter apparatus in its entirety with the fluid inlet arranged on the left and the fluid outlet arranged on the right, looking towards the FIG;

FIG. 2 is a partial view of the upper part of the example filter apparatus according to FIG. 1, rotated through 180° around the longitudinal axis of the filter apparatus, with the fluid inlet now on the right and the fluid outlet on the left, these being fluidically connected to one another in the illustrated release position;

FIG. 3 shows a view according to FIG. 2 in which the fluidic connection between the fluid inlet and the fluid outlet is now blocked in a blocking position;

FIG. 4 shows a view according to FIG. 3 with the filter element removed and with an open safety valve;

FIG. 5 shows a partial view in which an example coupling element of a rotary slide valve housing in the housing upper part is in contact with corresponding coupling elements on an end cap of the filter element to create a coupling connection;

FIG. 6 shows the coupling engagement according to FIG. 5 as a plan view with two mutually opposite coupling elements of the rotary slide valve housing and associated pairs of corresponding coupling elements on an example end cap of the filter element;

FIG. 7 shows the cap configuration of the end cap according to FIG. 6 in relation to the example filter element according to FIGS. 1 to 3;

FIG. 8 shows a longitudinal section through the end cap illustrated in FIG. 7;

FIG. 9 takes the form of an exploded view of parts of an example rotary slide valve housing with adjacently arranged parts of a housing lower part with the filter element inserted and associated upper end cap;

FIG. 10 shows an inclined view of the rotary slide valve housing according to FIG. 9; and

FIGS. 11 and 12 respectively show a longitudinal sectional view and a view from beneath individual components of the rotary slide valve housing according to FIGS. 9 and 10.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, it is provided that the control device comprises a rotary slide valve housing with at least one coupling element, which cooperates with corresponding coupling elements on the filter element as the actuation device so as to form at least one coupling such that, when the housing lower part is attached or removed, at least one of the corresponding coupling elements in each case comes into driveable contact with each assignable coupling element of the rotary slide valve housing and this is moved from the blocking position into the release position or vice versa, with subsequent release of the relevant coupling as soon as one of the positions is assumed by the rotary slide valve housing, all essential operating elements for actuating the control device are created between the rotary slide valve housing and the adjacent end of the filter element, which is beneficial for functional reliability. Furthermore, the corresponding arrangement can be implemented in a particularly space-saving manner. This also leads to a direct application of force between the actuation device of the filter element and the adjacent rotary slide valve housing as the control device such that actuation is possible without obstruction. Furthermore, spring-loaded valves, which are generally susceptible to faults, do not need to be used to construct the control device. As such, particularly reliable fluid flows can be obtained in hydraulic devices that are accordingly connected to the filter apparatus and/or the filter element.

In some embodiments of the filter apparatus, it is provided that the respective coupling is configured in the form of a ratchet coupling and has two adjacent mutually opposite pairs of spring tongues as corresponding coupling elements on an end cap of the filter element, which protrude in a resiliently yielding manner into a movement path of at least one control cam as one coupling element of the rotary slide valve housing. In this manner the respective control cam of the rotary slide valve housing forms one respective coupling element and the adjacent mutually opposite pairs of spring tongues form the corresponding coupling elements on the filter element. By virtue of the fact that, unlike in the prior art, the ratchet coupling is relocated from the bottom side of the filter element onto the top side thereof and no longer interacts with the housing lower part, but instead interacts with the rotary slide valve housing in the housing upper part, the housing lower part in its entirety is able to form a filter bowl which is closed to the outside and which is screwed in its entirety to a filter head as the housing upper part in the operating position. Segmentation of the filter bowl into one part which is an integral part of the filter head and another part for carrying out the rotational movement for the filter element via the ratchet coupling on the bottom side is thus avoided such that the structure of the filter apparatus in its entirety is simplified and can thus be produced cost-effectively. The necessary seal between the filter bowl and the filter head is also simplified, as is dismantling the filter bowl from the filter head along with reattaching subsequently.

In some embodiments of the filter apparatus, it is provided that the rotary slide valve housing comprises two fluid passage points and two blocking walls, which can each be moved to cover the fluid inlet and outlet in the release or blocking position respectively.

As a result, by having the rotary slide valve housing in a central position in the filter head, it is possible to both block the fluid inlet and the fluid outlet when changing an element, which increases functional reliability. In a desirable manner, an increased pressure loss thus also arises if a filter element is not installed in the apparatus, which is generally due to an oversight and can be detected.

In some embodiments of the filter apparatus, it is provided that the rotary slide valve housing comprises a further control cam which is guided in a sliding guide in the housing upper part and delimits the displacement movement of the rotary slide valve housing between the blocking and release position. Thanks to the sliding guide, the position of the rotary slide valve housing is secured in its end positions and malfunctions are excluded in this manner.

In some embodiments of the filter apparatus, it is provided that a driver exists between the filter element and the housing lower part, said driver driving the filter element received in the housing lower part in the same direction in the event of a relative movement between the housing upper part, which is arranged in a stationary position, and the housing lower part, which can be moved towards it. By coupling the filter bowl as a housing lower part to the filter element via a corresponding driver, both a friction-locking and a form-locking connection is achieved, which allows a secure rotary drive operation for the filter element both when screwing on and unscrewing the filter bowl on or off the filter head with the result that the actuation device always actuates the control device accordingly.

In some embodiments of the filter apparatus, it is provided that the rotary slide valve housing, on the side of the fluid outlet in the housing upper part, has an annular seal which, in the release position, seals the fluid transition between the fluid outlet and an inner fluid passage in the rotary slide valve housing. An average expert in the field would find it surprising that only one annular seal is required on the outlet side of the filter apparatus and further sealing devices, especially on the inlet side, can be dispensed with. One seal on the outlet side is thus sufficient with the lower fluid pressure compared to the inlet side of the filter apparatus.

In some embodiments of the filter apparatus, it is provided that the inner fluid passage passes through the rotary slide valve housing at a right angle and, on its free end facing away from the fluid outlet, has a connection slope for fluidic connection of the filter element on the inside thereof. Thanks to the fluid passage at a right angle, flow losses and cavitation are avoided and thanks to the predefinable geometry on the aforementioned connection slope a kind of counterfeit protection is created, ensuring that only original high-quality filter elements can ever be used as replacement elements in the filter apparatus.

In some embodiments, it is provided that the rotary slide valve housing has a further inner fluid passage which, in the release position, creates a fluidic connection between the fluid inlet and a fluid chamber formed by the filter element and the housing lower part in an operating position. In this manner, an oblique plane is created on the fluid inlet side, i.e., on the contaminated side inside the rotary slide valve housing in the filter head, which in turn helps avoid flow losses and cavitation.

In some embodiments of the filter apparatus, it is provided that the rotary slide valve housing has at least one safety valve, which opens when flow passes through the rotary slide valve housing in its blocking position from the fluid inlet to the fluid outlet and releases the corresponding fluid path, bypassing the fluid chamber in the housing lower part, and in that a contamination display is for example connected in the corresponding fluid path. This thus ensures that, in the event of the flow passing through the filter apparatus in an undesirable manner, without a filter element inserted, via safety passages in the rotary slide valve housing, a preload valve forming the safety valve can be actuated, said preload valve opening in the event of a set preload pressure and creating a fluid safety connection between the inlet and the outlet without any dangerous build-up of pressure. If, for example, a contamination display, which may be configured as a differential pressure display, is connected in the corresponding fluid path, a corresponding malfunction can be indicated via this contamination display. Thus, the absence of the filter element in the operating position of the filter apparatus can be safely detected and avoided accordingly. The technical structure of such contamination displays is disclosed in DE 10 2014 014 37 A1, incorporated by reference herein and filed by the proprietor of the property right, by way of example.

For example, it is further provided that at least one bypass valve is received in the rotary slide valve housing, said bypass valve, in the release position, releasing the fluid path between the fluid inlet and outlet during operation when a predefinable level of contamination of the filter element is exceeded, bypassing said filter element. In this manner, the function of a hydraulic system connected to the filter apparatus can be guaranteed, said system also being supplied with fluid at a predefinable pressure if the filter element is clogged or blocked respectively.

An improved control of fluid flows in connection with hydraulic devices in a functionally reliable manner is also provided by a filter element. In some embodiments, the filter element with its element material, which has an end cap on at least one free end face, comprises individual coupling elements on this end cap, said coupling elements protruding outwards as part of at least one coupling, an actuation device is created directly on the top end of the filter element, by means of which device it is possible to control the fluid flows between a fluid inlet and a fluid outlet in a functionally reliable manner by means of further coupling elements on a control device of a filter apparatus. In particular, interaction of the actuation device on the filter element with the control device on a filter housing of the filter apparatus makes it possible to ensure that the filter apparatus cannot be operated if the filter element is missing. In this manner, operator errors can be ruled out and reliable control of fluid flows in a hydraulic system that is fluidically connected to the filter element is guaranteed.

In this case, it is for example provided that the coupling elements of the end cap are formed by at least one pair, for example by two pairs, of mutually adjacent opposite spring tongues which each protrude inwards for a predefinable distance along a movement path. In this manner, key components in a kind of ratchet coupling are provided on the filter element, ensuring that the control device, which is generally in the form of a rotary slide valve housing, continues to be actuated even if the filter element is not yet completely removed or inserted in its operating position.

The movement path is for example delimited by shell-like guide surfaces as part of the respective coupling, which protrude over the assignable end cap and are delimited at the ends by a spring tongue in each case. Thanks to the combination of a movement path with elastically resilient spring tongues, this on the one hand ensures reliable guidance of coupling elements of the rotary slide valve housing and filter element that can be coupled to one another and, on the other hand, that the actuation device can be deactivated as soon as the rotary slide valve housing is in its respective blocking or releasing position in the filter housing.

In some embodiments of the filter element, it is provided that the shell-like guide surfaces are surrounded on the outside by a holding ring, which, viewed in the axial direction, at least partially protrudes over the guide surfaces and is securely connected, for example integrally, via webs to the assignable end cap. For example, in this process, the holding ring protrudes at its edges over the end cap and has at least one protruding driver in the direction of said end cap. In this manner, by means of the holding ring and its driver, a friction-locking and form-locking fixing opportunity is provided and, moreover, the coupling elements on the filter element are protected from mechanical damage. Furthermore, thanks to the combination of the holding ring and the coupling elements, this provides a rigid independent structure for the filter element via the associated end cap.

In a particularly beneficial manner, it is provided that a socket joint is pivotally incorporated in a central opening of the end cap, said joint having a connection point that can be inclined in predefinable directions to form a fluid passage to the inside of the filter element. While the holding ring provides a rigid connection option for receiving the filter element, a central fluid passage starting from inside the filter element can be achieved in a sealed manner via the movable, in particular inclinable, connection point. In this process, an average expert in the field would find it surprising that, on the one hand, a stationary secure positioning of the filter element in its entirety can be achieved via the holding ring, and, in connection with the fluid passage, variability can be obtained via the socket joint, which also has the benefit that any tolerance differences between the element holder and the fluid passage can be compensated directly.

In a particularly space-saving manner, it is in this case provided that end parts of the element material surround the socket joint in an end cap holder such that the socket joint is also supported on the outside by the element material and obstacle-free adaptation of the socket joint to its connection point is thus possible in that this can be moved without any force into its fluid-conveying operating position.

Reference will now be made to the drawings in which the various elements of embodiments will be given numerical designations and in which further embodiments will be discussed. Specific references to components, process steps, and other elements are not intended to be limiting. The FIGS. Are schematic and not necessarily to scale.

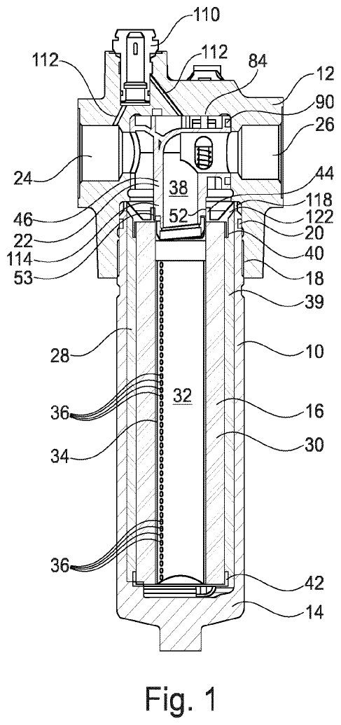

The filter apparatus shown in FIG. 1 comprises a filter housing 10 consisting of a housing upper part 12 and a housing lower part 14, which are also referred to in technical jargon as a filter head or filter bowl respectively. The housing lower part 14 is provided for exchangeably receiving a filter element 16. The housing upper part 12 is generally arranged in a stationary or fixed manner as part of an overall hydraulic arrangement and the housing lower part 14 can be securely releasably connected to the housing upper part 12 via a threaded section 18. In particular, in this manner, the housing lower part 14, forming the threaded section 18 with a corresponding male thread, can be screwed into a female thread of the housing upper part 12 in a releasable manner. Looking at FIG. 1, a circumferential annular groove 20 is arranged above the male thread of the housing lower part 14, said groove being intended to receive an annular seal, which is not shown, in order to thus seal the inside of the filter apparatus from the environment at this point.

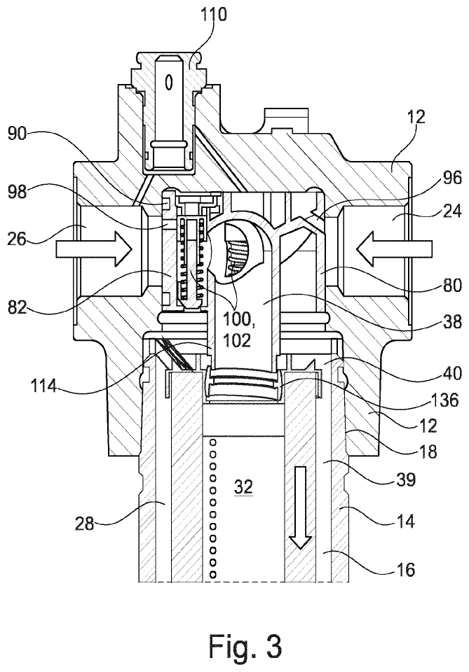

A control device 22 is received in the housing upper part 12 to control fluid flows in the housing upper part 12, the control device 22 blocking a fluidic connection between a fluid inlet 24 and a fluid outlet 26 in a blocking position as depicted in FIG. 3 and releasing said connection again in the release position shown in FIG. 1. Both the fluid inlet 24 and the fluid outlet 26 are connected to standard pipework, which is not shown, to the hydraulic (overall) apparatus. In this manner, fluid, for example in the form of a hydraulic medium, can be cleaned of particulate contamination by means of the filter apparatus according to FIG. 1. For this purpose, unfiltered medium flows via the fluid inlet 24 into a hollow-cylindrical fluid chamber 28, which is delimited on its outer circumferential side by the cylindrical inner wall of the housing lower part 14 and by the outer circumferential jacket of the filter element 16 which is usually configured to be pleated.

The unfiltered medium flow then passes from the fluid chamber 28 from the outside to the inside and, as it flows through the cleaning element material 30, to the inner side 32 of the filter element 16. As it flows accordingly through the element material 30, this is supported along the outer jacket of a hollow-cylindrical support tube 34, the fluid passages 36 of which are only partially reproduced in FIG. 1. The element material 30 cleans particulate contamination, if present, from the fluid flow such that the inner side 32 of the filter element 16 forms the so-called filtrate side of the filter apparatus during operation of said apparatus. The cleaned fluid then passes into the fluid outlet 26 via a right-angled inner fluid passage 38 in the control device 22 for subsequent use. As such, a further inner fluid passage 39 is thus formed by the fluid path from the inlet 26 to the fluid chamber 28 with the filter element 16.

The element material 30 of the filter element 16 is received between an upper end cap 40 and a lower end cap 42 as depicted in FIG. 1. The corresponding end caps 40, 42 serve as end enclosures for the free end faces of the element material 30 in the customary manner. With regard to the specific structure of the upper end cap 40, this will be explained in further detail below; however, the lower end cap 42 is supported in the customary manner on the bowl or bottom side of the housing lower part 14 or filter bowl respectively.

The upper end cap 40 has an actuation device 44, by means of which the aforementioned control device 22 can be actuated such that, when the housing lower part 14 is disconnected from the housing upper part 12, the control device 22 passes into the blocking position and, when the housing lower part 14 is attached to the housing upper part 12, the release position is formed as shown in FIG. 1.

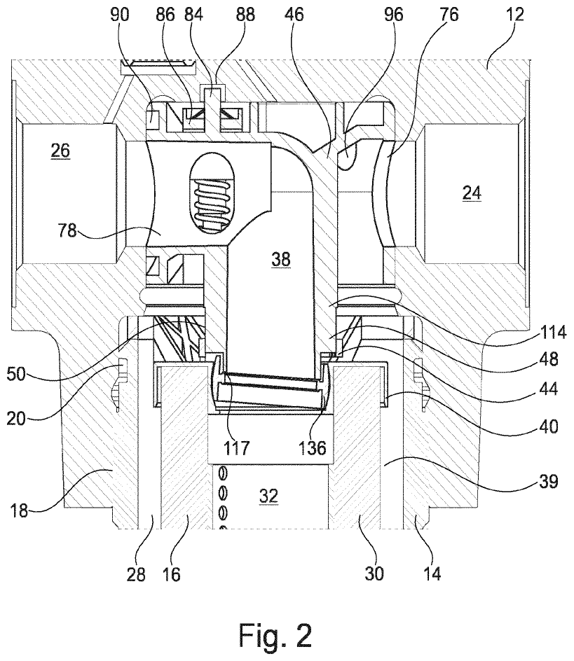

The drawing in FIG. 2 shows the housing upper part 12 in a view in which, turned through 180° in relation to the longitudinal axis of the filter apparatus, the fluid inlet 24 is now arranged on the right, and the fluid outlet 26 to the left thereof when looking at FIG. 2. Otherwise, the components illustrated in FIG. 2 correspond to the solution shown in FIG. 1. As is also depicted in FIG. 2, the control device 22 comprises a rotary slide valve housing 46 with two coupling elements 48, 50 lying diametrically opposite one another in relation to the aforementioned longitudinal axis, said coupling elements interacting with corresponding coupling elements 54, 56, 58, 60 on the filter element 16 as the actuation device 44 to form two couplings 52, 53 such that, when the housing lower part 14 is attached or removed, at least one of the corresponding coupling elements 54, 56, 58, 60 on the filter element 16 in each case comes into driveable contact with each assignable coupling element 48, 50 of the rotary slide valve housing 46 and this is moved from the blocking position shown in FIG. 3 into the release position shown in FIGS. 1 and 2 or vice versa, with subsequent release of the relevant coupling 52, 53 as soon as one of the positions is assumed by the rotary slide valve housing 46.

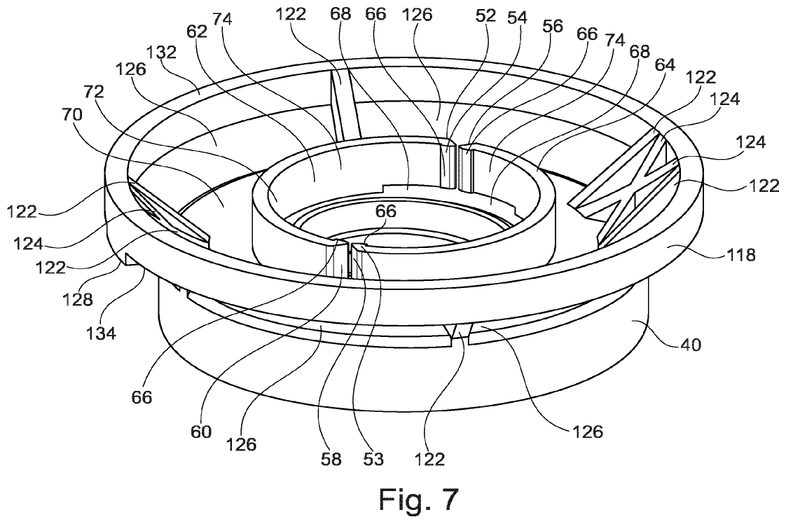

The respective coupling solution on the upper end cap 40 can be seen on FIG. 7 in particular. Starting from the fluid-permeable centre of the upper end cap 40, two half-shells 62, 64, protruding axially upwards, are provided, said half-shells for example being an integral part of the upper end cap 40, which can, for example, be produced by a plastic injection moulding process or by 3D printing. The two half-shells 62, 24 each have a corresponding coupling element 54, 60 or 56, 58 respectively on their free mutually opposite ends. Thus, the corresponding coupling elements 54 and 56 or 58 and 60, which are adjacent to one another, form part of the respective coupling 52 or 53 respectively. The respective corresponding coupling element 54, 56, 58 and 60 is formed by an elastically resilient spring tongue, which, at its free end, has an inwardly protruding latching nose 66. The respective spring tongue with its latching nose 66 is formed by a bottom recess 68 in the respective half-shell 62, 64, in the form of a bottom recess opposite the upper side 70 of the upper end cap 40, which, in this manner, in the operating position of the filter apparatus, runs horizontally, substantially as a continuous surface. In this process, the spring tongues with their protruding latching noses 66 protrude inwards, as viewed on FIG. 7, by a predefinable distance along a circular movement path 72, which is also delimited by the inner guide surfaces 74 of the half-shells 62, 64.

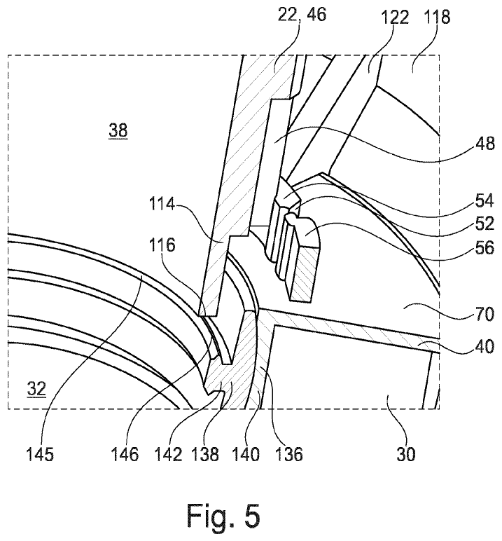

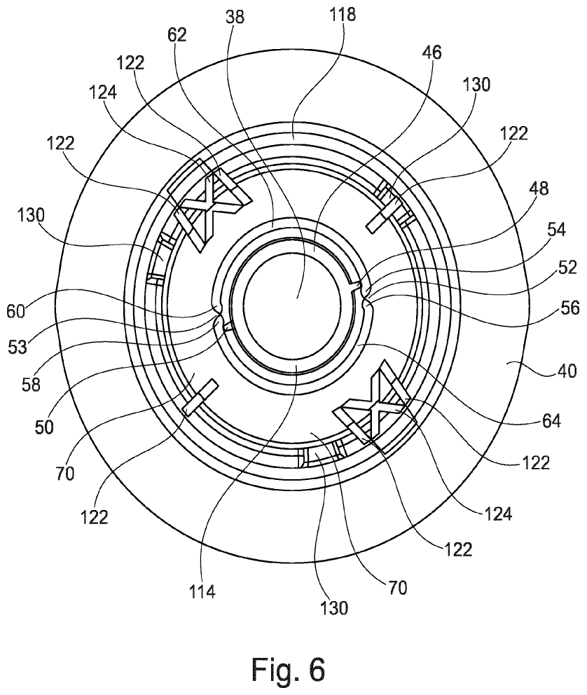

If the housing lower part 14, as viewed on FIGS. 5 and 6, is screwed anticlockwise onto the housing upper part 12 from beneath, and if the control device 22 or the rotary slide valve housing 46 respectively is in its position blocking the fluidic connection between inlet 24 and outlet 26 as depicted in FIG. 3, the latching noses 66 of the corresponding mutually diametrically opposite coupling elements 54, 58 of the two half-shells 62, 64 carry the adjacently opposite coupling elements 48 and 50 of the control device 22 with them as soon as these come into engagement with one another from beneath as part of the screwing-on process, and in so doing rotate the rotary slide valve housing 46 into its release position as depicted on FIGS. 1 and 2. If the rotary slide valve housing 46 is pivoted into its corresponding release position, but the housing lower part 14 with the filter element 16 is potentially not completely screwed on, the respective coupling 52, 53 acts as a ratchet coupling and the coupling elements 48, 50 in one end position are passed over by the corresponding coupling elements 54, 60; 56, 58 without triggering a further actuation. Accordingly, when further screwing on the housing lower part 14, the control device 22 or the rotary slide valve housing 46 respectively remains in the release position adopted according to FIGS. 1 and 2.

If, for example, for the purpose of replacing a used filter element 14 with a new element, the housing lower part 14 is then screwed off the housing upper part 12 in the clockwise direction, opposite the direction of rotation described previously, the latching noses 66 of the corresponding coupling elements 56, 60 then potentially only come into contact with the control cams, which are diametrically opposite one another in relation to the longitudinal axis of the apparatus, or coupling elements 48, 50 of the rotary slide valve housing 46, after passing over the ratchet coupling 52, 53, and move said rotary slide valve housing from its release position as depicted in FIGS. 1 and 2 into the blocking position for the fluid passage shown in FIG. 3. The aforementioned FIGS. 5 and 6 show the possible rotation status in this process if the rotary slide valve housing 46 is to move from its blocking position into its fluid-conveying starting or release position.

As is also shown in particular in FIGS. 2 and 3, the rotary slide valve housing 46 is configured in the form of a shut-off valve or plug valve as part of a changeover valve and, in addition to two fluid passage points 76, 78 (FIG. 2), also has two blocking walls 80, 82 (FIG. 3), which, in the release position or blocking position respectively, can each be brought to cover the fluid inlet 24 and fluid outlet 26. The two arrows depicted in opposite directions in FIG. 3 in the inlet 24 and in the outlet 26 in this case symbolise that the filter element 16 is in any event disconnected from the corresponding fluid passage in the blocking position in both possible fluid flow directions.

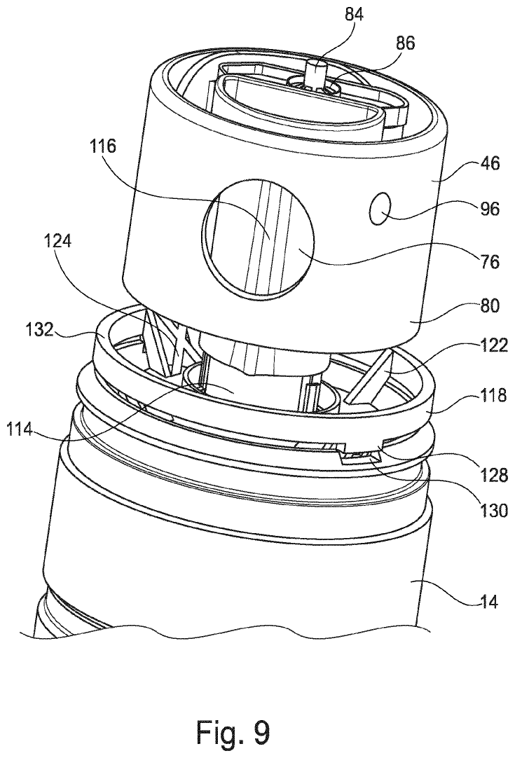

As is also shown in FIG. 2 and in FIGS. 9 to 11, the rotary slide valve housing 46 has a further cylindrical control cam 84 at the top, as viewed in the aforementioned figures, said cam being an integral component of the rotary slide valve housing 46 and, on its circumference, is supported by a kind of central or spring centring means 86. The corresponding further control cam 84 is guided in an associated sliding guide 88 (FIG. 2) in the housing upper part 12 such that the possible displacement movements of the rotary slide valve housing 46 between the blocking position shown in FIG. 3 and the release position shown in FIG. 2 are delimited in both pivot directions. This thus prevents the rotary slide valve housing 46 being continuously carried along in an undesirable manner via the respective coupling 52, 53 and as such coming into undesirable intermediate positions if relative movements arise between the housing lower part 14 and the housing upper part 12 due to screwing-on or -off processes.

As is also shown in FIGS. 2, 3 and FIGS. 10 and 12, the rotary slide valve housing 46 has an annular seal on the side of the fluid outlet 26 in the housing upper part 12, said seal not being shown in further detail, merely the associated receptacle 90 for a corresponding annular seal. As the annular seal is required to cover a plurality of fluid openings, which will be explained in further detail, the associated annular receptacle 90 is furnished with intermediate portions 92 running in a straight line between the adjacent curves 94 such as to form a kind of flattened sealing oval.

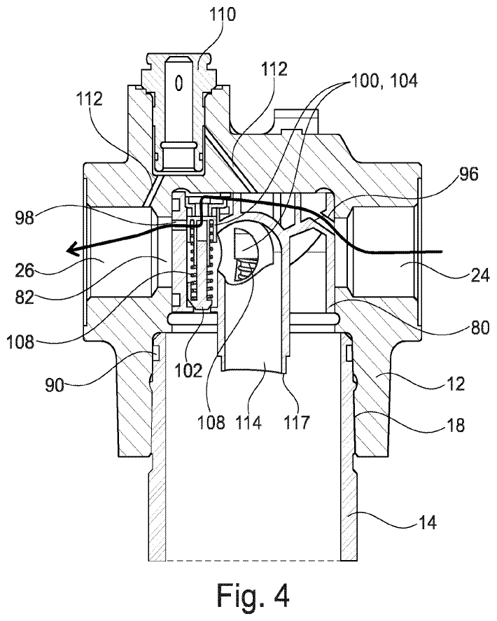

As depicted in FIG. 4 in particular, which shows the filter apparatus in its blocking position and without the filter element 16 inserted in the bowl-shaped housing lower part 14, a possible fluid path is opened between the fluid inlet 24 and the fluid outlet 26, which is indicated in FIG. 4 with a throughflow arrow showing the possible fluid path. For the corresponding fluid passage, the two blocking walls 80, 82, which are diametrically opposite one another, each have an additional fluid opening 96 or 98 respectively, via which the possible fluid flow from the fluid inlet 24 via the facing fluid opening 96 of the first blocking wall 80 passes to the inner side of the rotary slide valve housing 46 and from there via the further fluid opening 98 in the blocking wall 82 onto the side with the fluid outlet 26. As such, the rotary slide valve housing 46, which is configured in the form of a hollow chamber structure, is equipped with a corresponding free fluid path between the supporting chamber walls inside the rotary slide valve housing 46.

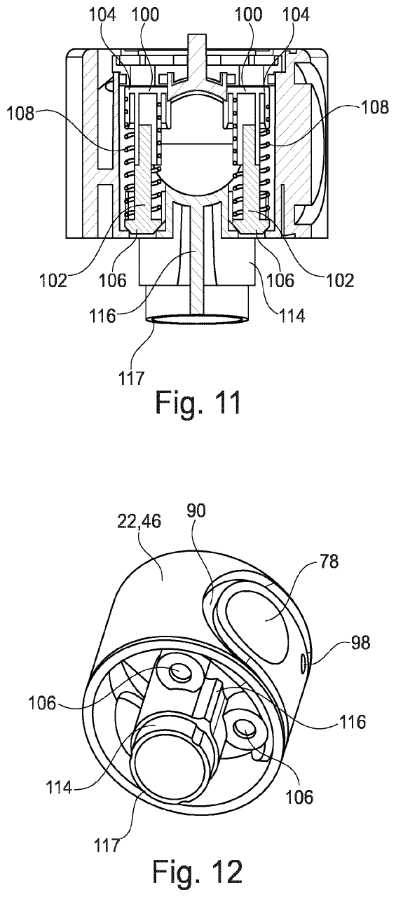

Furthermore, as depicted in the sectional view through the rotary slide valve housing 46 according to FIG. 11, two safety valves 100 are located inside the illustrated possible fluid path shown in FIG. 4. The respective safety valve 100 is configured as what is known as a double valve, i.e. the respective safety valve 100 also still has the function of a bypass valve 102. To this end, the respective valve 100, 102 comprises associated pairs of closing parts 104 or 106 respectively, which are assigned to one another in pairs and each supported on a coupling spring 108, which is configured as a compression spring. Accordingly, both a safety valve function and a bypass function can be performed by just one valve structure. A preload pressure can be predefined for the respective valve function via the coupling spring 108 and, if the pressure exceeds a predefinable threshold value at the fluid inlet 24, both associated safety valves 100 open, one of which is only partially shown in FIG. 4. Accordingly, if the flow flows incorrectly through the filter apparatus without a filter element 16 via the respective safety holes in the form of the additional fluid openings 96, 98 in the rotary slide valve housing 46, the respective preload or safety valves 100 are actuated, with the bypass valves 102 closed, and in this manner an unacceptably high fluid pressure is unable to build up on the inlet side 24 of the filter apparatus.

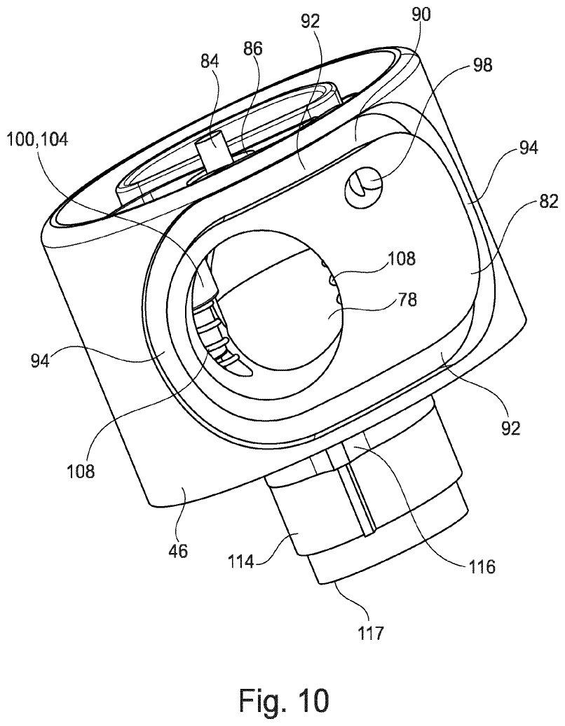

A contamination display 110 is screwed into the housing upper part 12 from above, said display being configured as a differential pressure sensor to measure and record the differential pressure between two fluid channels 112, one fluid channel 112 leading to the inside of the housing upper part 12, in which the rotary slide valve housing 46 is pivotally mounted, and the other fluid channel 112 emerging into the fluid outlet 26 as depicted on FIG. 4. If the set preload pressure is exceeded, this can be detected from the differential pressure or contamination display 110, thus ruling out operator errors for the filter apparatus, i.e. operation of the filter apparatus without a filter element 16 can be ruled out. As is shown in FIG. 10 in particular, the fluid passage point 78 and the additional fluid opening 98 in the blocking wall 82 are in all cases surrounded at their edges by the oval annular seal in the corresponding receptacle 90 and in this manner sealed from the environment.

If the filter apparatus is in its filtering operating position as depicted in FIG. 2 and what is known as a blockage of the filter element 16 with particulate contamination comes about, the bypass valves 102 open, bypassing the fluid chamber 28 with the filter element 16, releasing a direct path from the fluid inlet 24 to the fluid outlet 26 so that the function of an overall hydraulic system to which the filter apparatus is connected is not impaired or even interrupted. FIG. 12 is a view from beneath the rotary slide valve housing 46 showing the respective holder for the valves 100, 102 and the closure parts 106 for the respective spring-loaded bypass valve 102.

As is also shown in FIGS. 11 and 12, in the region of the bottom connector 114, which emerges with its free lower end 117 into the upper end region of the screwed-on housing lower part 14, a wedge-shaped flow divider 116 is provided, which serves to reduce pressure losses during operation both on the outlet side and on the inlet side of the rotary slide valve housing 46, and in this process is pivoted centrally into the outlet 26 or inlet 24 respectively in the release position.

The connection of the housing lower part 12 to the upper end cap 40 of the filter element 16 is described in greater detail below along with more details of the structure of the upper end cap 40.

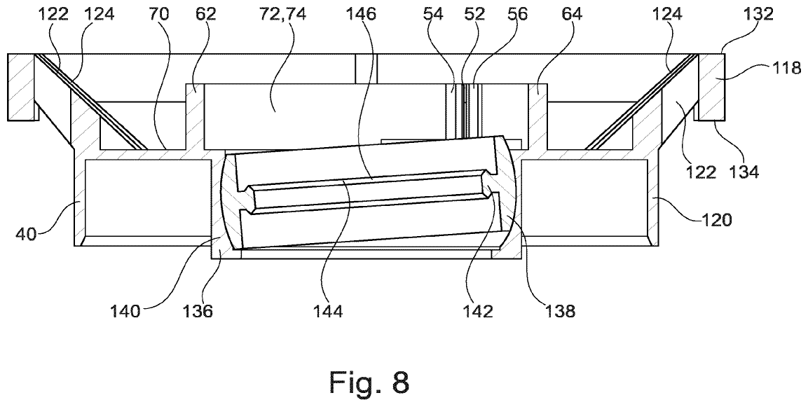

As shown in FIGS. 7 and 8 in particular, the upper end cap 40 has a circumferential circular holding ring 118 which has a wider diameter on its outer circumferential side and protrudes axially and radially over an element holder 120 on the ring side, which serves to hold the upper free end face of the pleated element material 30, although this is not shown in FIGS. 7 and 8 for ease of representation. The holding ring 118 is integrally connected via obliquely extending holding webs 122 to the upper side 70 of the end cap 40, two mutually diametrically opposite holding webs 122 being provided for further reinforcement with webs 124 extending crosswise. The holding ring 118 with its webs 122, 124 is in any event an integral part of the upper end cap 40 such that annular segment-like fluid passages 126 are provided between the upper side 70 of the end cap 40 and the holding ring 118, by means of which the unfiltered medium is able to flow from the fluid inlet 24 into the fluid chamber 28 with the filter element 16 from above so as to then, in this manner, flow through the element material 30 from the outside to the inside such that a fluid flow from the fluid chamber 28 to the inner side 32 of the filter element 16 is thus present. The unfiltered medium flow is thus, in this manner, passed outside the element holder 120 in a hollow chamber between the cylindrical inner side of the holding ring 118 and the cylindrical outer side of the upper element cap 40.

The holding ring 118 has, for example on its end edge, pointing downwards, at least one driver 128, but for example two or three drivers 128 (FIG. 6), which extend such that they are spaced equidistantly from one another on the underside of the holding ring 118. As shown in FIG. 9 in particular, the associated bowl-shaped housing lower part 14 has, on its free upper end face, rectangular recesses 130 in which the respective driver 128 can engage precisely from above. When the holding ring 118 is fully positioned on the upper side of the housing lower part 14, both a friction-locking and a form-locking connection of the filter element 16 to the housing lower part 14 via the upper end cap 40 is achieved in this manner via the pairs of drivers 128 with recesses 130. In this manner, the filter element 16 can be driven in the same direction of rotation with the housing lower part 14 both in the screwing-on movement and in the screwing-off movement. If, as depicted in FIG. 1, the housing lower part 14 is screwed on in the functional or operating position, the holding ring 118 with its opposite upper and lower end faces 132 and 134 comes into contact with adjacent wall parts of the housing upper part 12 or the housing lower part 14 respectively, thus fixing its position. In this manner, a secure clamped fixing of the filter element 16 is achieved via the holding ring 118 between the housing upper part 12 and the housing lower part 14 in the operating position.

As is also shown in particular in FIG. 8, a socket joint 136 is provided in concentric arrangement with the central opening of the element cap 40, said socket joint having a shell part 138, which is pivotally mounted in a shell holder 140 in the form of a spherical cap. The hollow-cylindrical shell part 136 has at its centre, on at least one holding web 142, which is for example connected in an annular manner to the inside of the pivotable shell part 138, an annular sealing surface 144, which forms a seal with the pivotable rotary slide valve housing 46 in the operating position as soon as said valve housing comes into contact with the upper side of the sealing ring 144 with its lower free edge 117 of the connector 114. For this purpose, the sealing ring 144 for example has an angled or roof-shaped sealing edge 146, which forms the seal with the free end face of the lower contact surface 117 of the connector 114 of the rotary slide valve housing 46 (FIG. 5). The accordingly circumferential sealing edge 146 is freely pivotable via the socket joint 136, i.e., the shell part 138, which is movably arranged such that it can pivot inside the shell holder 140 with its connection point 145, can automatically adapt to the connection geometry of the connector 114 of the rotary slide valve housing 46. In this manner, tolerance differences between the connector 114 and the sealing ring 144 can be compensated inside the socket joint 136. Even if the connector 114, as depicted in FIG. 2, has an extreme slope on its free lower end, the sealing ring 144 is able to readily compensate for this difference via the socket joint 136 and create a reliably sealed inner fluid passage 38 between the outlet side 26 of the filter apparatus and the inner or filtrate side 32 of the filter element 16 via the sealing edge 146 of the sealing ring 144. Counterfeit protection can also be achieved by selecting an appropriate connection geometry on the control device 22 or on the rotary slide valve housing 46 respectively. This therefore has no parallel in the prior art.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-17. (canceled)

18. A filter apparatus comprising a filter housing at least comprising a housing upper part and a housing lower part, which is provided for exchangeably receiving a filter element at least partly, and comprising a controller for controlling fluid flows in the housing upper part, said controller, in a blocking position, blocking a fluidic connection between a fluid inlet and a fluid outlet and, in a release position, releasing said fluidic connection, wherein, using an actuation device on the filter element, the controller can be controlled such that, when the housing lower part is disconnected from the housing upper part, the controller moves into the blocking position and, when the housing lower part is attached to the housing upper part, the release position is established, wherein the controller comprises a rotary slide valve housing with at least one coupling element, which cooperates with corresponding coupling elements on the filter element as the actuation device so as to form at least one coupling such that, when the housing lower part is attached or removed, at least one of the corresponding coupling elements in each case comes into driveable contact with each assignable coupling element of the rotary slide valve housing and this is moved from the blocking position into the release position or vice versa, with subsequent release of the relevant coupling as soon as one of the positions is assumed by the rotary slide valve housing.

19. The filter apparatus of claim 18, wherein the respective coupling is configured in the form of a ratchet coupling and has two adjacent mutually opposite pairs of spring tongues as corresponding coupling elements on an end cap of the filter element, which protrude in a resiliently yielding manner into a movement path of at least one control cam as one coupling element of the rotary slide valve housing.

20. The filter apparatus of claim 18, wherein the rotary slide valve housing comprises two fluid passage points and two blocking walls, which can each be moved to cover the fluid inlet and outlet in the release or blocking position respectively.

21. The filter apparatus of claim 18, wherein the rotary slide valve housing comprises a further control cam which is guided in a sliding guide in the housing upper part and delimits the displacement movement of the rotary slide valve housing between the blocking and release position.

22. The filter apparatus of claim 18, wherein a driver exists between the filter element and the housing lower part, said driver driving the filter element received in the housing lower part in the same direction in the event of a relative movement between the housing upper part, which is arranged in a stationary position, and the housing lower part, which can be moved towards it.

23. The filter apparatus of claim 18, wherein the rotary slide valve housing, on the side of the fluid outlet in the housing upper part, has a receptacle for an annular seal which, in the release position, seals the fluid transition between the fluid outlet and an inner fluid passage in the rotary slide valve housing.

24. The filter apparatus of claim 18, wherein the inner fluid passage passes through the rotary slide valve housing at a right angle and, on its free end facing away from the fluid outlet, has a connection slope for fluidic connection of the filter element on the inside thereof.

25. The filter apparatus of claim 18, wherein the rotary slide valve housing has a further inner fluid passage which, in the release position, creates a fluidic connection between the fluid inlet and a fluid chamber formed by the filter element and the housing lower part in an operating position.

26. The filter apparatus of claim 18, wherein the rotary slide valve housing has at least one safety valve, which opens when flow passes through the rotary slide valve housing in its blocking position from the fluid inlet to the fluid outlet and releases the corresponding fluid path, bypassing the fluid chamber in the housing lower part, and a contamination display is connected in the corresponding fluid path.

27. The filter apparatus of claim 18, wherein at least one bypass valve is received in the rotary slide valve housing, said bypass valve, in the release position, releasing the fluid path between the fluid inlet and outlet during operation when a predefinable level of contamination of the filter element is exceeded, bypassing said filter element.

28. A filter element, having an element material that has an end cap on at least one free end face, wherein the end cap comprises individual coupling elements which protrude outwards as part of at least one coupling.

29. The filter element of claim 28, wherein the coupling elements of the end cap are formed by at least one pair of mutually adjacent opposite spring tongues which each protrude inwards for a predefinable distance along a movement path.

30. The filter element of claim 28, wherein the movement path is delimited by shell-like guide surfaces as part of the respective coupling, which protrude over the assignable end cap and are delimited at the ends by a spring tongue in each case.

31. The filter element of claim 28, wherein the shell-like guide surfaces are surrounded on the outside by a holding ring, which, viewed in the axial direction, at least partially protrudes over the guide surfaces and is securely connected via webs to the assignable end cap.

32. The filter element of claim 28, wherein the holding ring protrudes at its edges over the end cap and has at least one protruding driver in the direction of said end cap.

33. The filter element of claim 28, wherein a socket joint is pivotally incorporated in a central opening of the end cap, said socket joint having a connection point that can be inclined in predefinable directions to form a fluid passage on the inside of the filter element.

34. The filter element of claim 28, wherein end parts of the element material surround the socket joint in an element holder of the end cap.

35. The filter apparatus of claim 19, wherein the rotary slide valve housing comprises two fluid passage points and two blocking walls, which can each be moved to cover the fluid inlet and outlet in the release or blocking position respectively.

36. The filter apparatus of claim 19, wherein the rotary slide valve housing comprises a further control cam which is guided in a sliding guide in the housing upper part and delimits the displacement movement of the rotary slide valve housing between the blocking and release position.

37. The filter apparatus of claim 20, wherein the rotary slide valve housing comprises a further control cam which is guided in a sliding guide in the housing upper part and delimits the displacement movement of the rotary slide valve housing between the blocking and release position.
